(19) United States
(12) Patent Application Publication
(10) Pub. No.: US 2018/0195791 A1
(43) Pub. Date: Jul. 12, 2018

(54) REFRIGERATOR

(71) Applicant: QINGDAO HAIGAO DESIGN & MANUFACTURING CO., LTD, Qingdao (CN)

(72) Inventors: Jian WU, Qingdao (CN); Shu ZHOU, Qingdao (CN); Zhaojun FEI, Qingdao (CN); Tianyu ZHAO, Qingdao (CN)

(21) Appl. No.: 15/741,162

(22) PCT Filed: Jun. 24, 2016
(86) PCT No.: PCT/CN2016/087071

§ 371 Date: Dec. 29, 2017

(30) Foreign Application Priority Data
Jun. 30, 2015 (CN) 201520460290.8

(51) Int. Cl. F25D 23/02; E05D 15/34

(52) U.S. Cl. CPC F25D 23/021; E05Y 2900/31; F25D 23/025; E05D 15/34

(57) ABSTRACT

A refrigerator comprises a case defining a storage compartment, and at least one door assembly. Each door assembly comprises: a door, arranged in front of the case and used for opening or closing the storage compartment; and at least one translation hinge. Each translation hinge has two swing arms, and two ends of each swing arm directly or indirectly mounted rotatably on the door and the case relative to the door and the case, so that each translation hinge and the door and the case form a parallelogram-shaped mechanism, allowing the door to translate to open or close the storage compartment.

### TECHNICAL FIELD

The present invention relates to a refrigeration apparatus, in particular to a refrigerator.

### BACKGROUND OF THE INVENTION

The existing refrigerator door is generally pivotally mounted to the front of a case, which is opened or closed by rotating around the axis of rotation of a lateral end of the refrigerator door. However, such a rotatably-mounted door requires sufficient clearance space in front of the refrigerator, and when opening the door, an operator needs to move backwards to make a space for the door, which is rather inconvenient. In addition, a common rotatably-mounted door can open to about 90°, which causes inconvenient access to the interior of the refrigerator. In some cases, if the side face of the refrigerator faces a light source, when the door is opened, the door can also prevent natural light or lamplight from entering the interior of the refrigerator.

### SUMMARY OF THE INVENTION

An object of the present invention is to provide a refrigerator to solve one of the above-mentioned defects existing in the prior art.

Specifically, the present invention provides a refrigerator, which comprises a case defining a storage space, and at least one door assembly, characterized in that each door assembly comprises: a door provided in front of the case and used for opening or closing the storage space; and at least one translation hinge, wherein each translation hinge has two swing arms, and two ends of each swing arm are directly or indirectly mounted rotatably on the door and the case relative to the door and the case, respectively, such that each translation hinge and the door and the case form a parallelogram-shaped mechanism, allowing the door to translate to open or close the storage space.

Optionally, the translation hinge further comprises a first connector fixed to an inner side surface of the door, one end of each swing arm being rotatably mounted to the first connector.

Optionally, the first connector comprises a body part fixed to the lateral side of the inner side surface of the door, and a bent part bent backwards from an end, away from the lateral centre of the door, of the body part; and one end of each of the two swing arms is rotatably mounted to the body part and the bent part, respectively.

Optionally, the translation hinge further comprises: a second connector fixed to the case, the other end of each swing arm being rotatably mounted to the second connector.

Optionally, the second connector comprises a base plate and a top plate which extend in the horizontal direction and are spaced apart from each other, and a connection part connected between the base plate and the top plate; and the other end of each swing arm is rotatably mounted between the base plate and the top plate.

Optionally, the number of the at least one translation hinge is two, and the two translation hinges are respectively arranged at the top and the bottom of the door.

Optionally, the base plate of the second connector of the upper translation hinge is mounted to a lateral end of a front edge of an upper surface of the case.

Optionally, the bottom of the case is provided with an accommodating groove having an opening facing forward and being used for accommodating the two swing arms; and the second connector of the lower translation hinge is mounted in the accommodating groove.

Optionally, the number of the at least one door assembly is two, and the two door assemblies are respectively mounted to two lateral sides in the front of the case, such that the two doors translate laterally toward each other so as to close the storage space and move laterally away from each other so as to open the storage space.

Optionally, the storage space is divided into a plurality of storage compartments, a plurality of door assemblies are provided, and each door assembly is mounted in front of one of the storage compartments so as to open or close the corresponding storage compartment.

In the refrigerator of the present invention, the door is mounted to the case via the translation hinge, and the translation hinge and the door and the case form a parallelogram-shaped mechanism such that the door can translate to open or close the case. Comparing the refrigerator of the present invention with the existing rotary door, opening the door of the present invention is quite convenient, and there is no need to reserve a clearance space for door opening in front of the refrigerator.

According to the detailed description of the particular embodiments of the present invention below in conjunction with the accompanying drawings, the above-mentioned and other objects, advantages and features of the present invention will be clearer to a person skilled in the art.

### BRIEF DESCRIPTION OF THE DRAWINGS

Some of the particular embodiments of the present invention will be described below in detail in an exemplary but not limiting way with reference to the accompanying drawings. The same reference signs in the figures indicate the same or similar components or parts. A person skilled in the art should understand that these figures are not necessarily drawn to scale. In the accompanying drawings:

FIG. 1 is a schematic exploded view of a refrigerator according to one embodiment of the present invention;

FIG. 2 is a schematic view of a translation hinge in the refrigerator as shown in FIG. 1;

FIG. 3 is a schematic view of the refrigerator as shown in FIG. 1, with the doors in a closed state; and

FIG. 4 is a schematic view of the refrigerator as shown in FIG. 1, with the doors in an opening state.

### DETAILED DESCRIPTION OF THE INVENTION

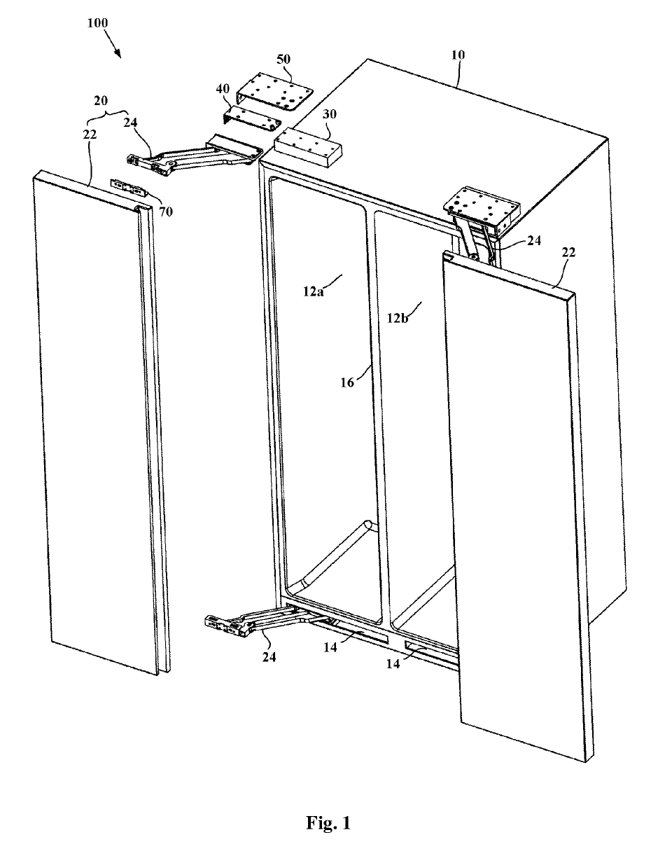

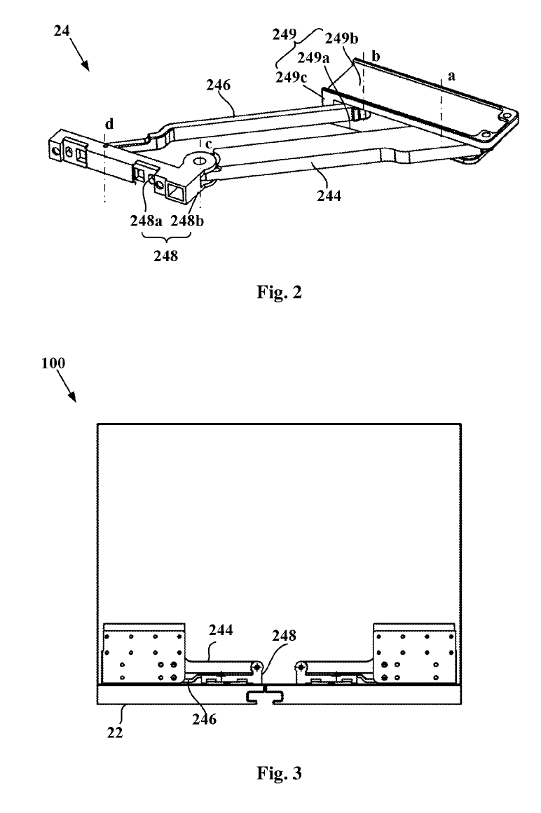

FIG. 1 is a schematic exploded view of a refrigerator according to one embodiment of the present invention, and FIG. 2 is a schematic view of a translation hinge in the refrigerator as shown in FIG. 1. As shown in FIG. 1 and FIG. 2, a refrigerator 100 comprises a case 10 and at least one door assembly 20, wherein the case 10 defines a storage space, which can be further divided into a plurality of storage compartments so as to meet the storage requirements of different articles. Each door assembly 20 comprises a door 22 and a translation hinge 24, the door 22 is provided in front of the case 10 to open or close the storage compartment 12, and the door 22 is connected to the case 10 via the translation hinge 24.

FIG. 2 schematically shows the structure of the translation hinge 24; as shown in FIG. 2, the translation hinge 24 comprises two swing arms, respectively being a first swing arm 244 and a second swing arm 246; two ends of the two swing arms are directly or indirectly mounted rotatably on the door 22 and the case 10 relative to the door 22 and the case 10, respectively, such that each translation hinge 24 and the door 22 and the case 10 form a parallelogram-shaped mechanism, allowing the door 22 to translate to open or close the storage space, that is, when the door is opened or closed, the door 22 is always parallel to the front surface of the case 10. In particular, pivotal axes of two swing arms on the case 10 are labelled as a and b; pivotal axes of the swing arms on the door 22 are labelled as c and d; the four axes a, b, c and d extend in a vertical direction; and the relative positions thereof should be set as the case where four projection points in the normal plane are four vertices of a parallelogram. In addition, a person skilled in the art should understand that the swing arm 244 and the swing arm 246 are not necessarily arranged in the same plane only if the relative positions of the pivotal axes thereof meet the above-mentioned requirements.

Preferably, in order to facilitate the manufacturing and assembly of various parts, the two swing arms are indirectly mounted to the door 22. Particularly, the translation hinge 24 not only comprises a first swing arm 244 and a second swing arm 246, but also comprises a first connector 248 fixed to an inner side surface of the door 22, one end of each of the first swing arm 244 and the second swing arm 246 being rotatably mounted to the first connector 248. Furthermore, a mounting member 70 in the shape of an “L” can also be provided. In the assembly process of the door assembly 20, the mounting member 70 in the shape of an “L” can firstly be fixed to an inner side surface of the door 22 by using a screw, then the two swing arms of the translation hinge 24 and the first connector 248 are assembled, and finally the first connector 248 is fixed to the mounting member 70 in the shape of an “L” in the way of threaded connections.

FIG. 3 is a schematic view of the refrigerator as shown in FIG. 1, with the doors in a closed state. In conjunction with FIG. 2 and FIG. 3, the common plane where the two pivotal axes c and d of the first connector 248 are located is not parallel to the inner side surface of the door 22, but the pivotal axis c of the first swing arm 244 is located behind the pivotal axis d of the second swing arm. In particular, the first connector 248 comprises a body part 248a fixed to the lateral side of the inner side surface of the door 22, and a bent part 248b bent backwards from an end, away from the lateral centre of the door 22, of the body part 248a; and one end of each of the first swing arm 244 and the second swing arm 246 is rotatably mounted to the body part 248a and the bent part 248b, respectively. So that when the door 22 is fully closed, the second swing arm 246 can be stacked in front of the first swing arm 244. Of course, if the two swing arms are staggered in the vertical direction (i.e. being not in the same horizontal plane), the first connector 248 does not need to adopt such a structure because their respective movements are not interfered by each other.

Likewise, the two swing arms are also indirectly mounted to the case 10, as shown in FIG. 2. The translation hinge 24 not only comprises a first swing arm 244, a second swing arm 246 and a first connector 248, but also comprises a second connector 249 fixed to the case 10, the other end of each of the first swing arm 244 and the second swing arm 246 being rotatably mounted to the second connector 249. The second connector 249 comprises a base plate 249a and a top plate 249b which extend in the horizontal direction and are spaced apart from each other, and a connection part 249c connected between the base plate 249a and the top plate 249b; and the other ends, of the first swing arm 244 and the second swing arm 246, are both rotatably mounted between the base plate 249a and the top plate 249b.

As shown in FIG. 1, in order to ensure the stability of the door 22, each door assembly 20 should have two translation hinges 24, which are respectively arranged at the top and the bottom of the door 22. Particularly, the second connector 249 of the upper translation hinge 24 is mounted to a lateral end of a front edge of an upper surface of the case 10. In some of the embodiments, a stop part 30, a first baffle plate 40 and a second baffle plate 50 are provided behind the second connector 249, so as to fix the second connector 249 in front of the stop part 30. The bottom of the case 10 is provided with an accommodating groove 14 having an opening facing forward and being used for accommodating the two swing arms; and the second connector 249 of the lower translation hinge 24 is mounted in the accommodating groove 14.

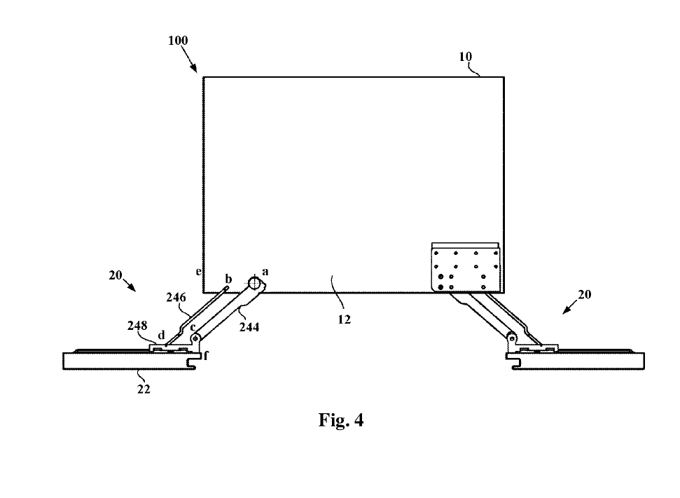

FIG. 4 is a schematic view of the refrigerator as shown in FIG. 1, with the doors in an opening state. The maximum allowable opening of the door 22 is related to the following parameters: a distance (hereinafter referred to as D (ac)) from the axis a to the axis c, a distance (hereinafter referred to as D (cf)) from the axis c to a side end face f of the door 22, and a distance (hereinafter referred to as D (ae)) from the axis a to a side end face e of the case 10. The inventor has learnt by calculation that, where D (ac)=D (cf)+D (ae), the swing arm is pivoted by 180 degrees to allow the door 22 to be fully opened (that is, the front of the storage space is not shielded at all), and where D (ac)>D (cf)+D (ae), the swing arm does not need to rotated to 180 degrees to allow the door 22 to be fully opened (see the state in FIG. 4).

The door assembly 20 in the present invention is especially suitable for a side-by-side refrigerator. In conjunction with FIG. 1 and FIG. 4, each refrigerator 100 comprises two door assemblies 20, which are respectively mounted to two lateral sides in front of the case 10, such that the two doors 22 translate laterally toward each other so as to close the storage space and move laterally away from each other so as to open the storage space.

Of course, for the refrigerator 100, the storage space therein is generally divided into a plurality of storage compartments, and for example, in the embodiment as shown in FIG. 1, the storage space is divided into a storage compartment 12a and a storage compartment 12b by a division plate 16. Further, the storage compartment 12a or the storage compartment 12b can also be further divided into a plurality of storage compartments (not shown in the figures), here a plurality of door assemblies 20 are provided, and each door assembly 20 is mounted in front of one of the storage compartments so as to open or close the corresponding storage compartment, so that other storage compartments are unaffected when access is made to the interior of the storage compartment.

Up to this, a person skilled in the art should recognize that although a plurality of embodiments of the present invention have been described in detail herein, numerous other variations or modifications meeting the principle of the present invention can be directly determined or derived according to the contents disclosed in the present invention. Therefore, the scope of the present invention should be construed and considered as covering all of such other variations or modifications.

What is claimed is:

1. A refrigerator, comprising a case defining a storage space, and at least one door assembly, wherein each door assembly comprises:
a door provided in front of the case and used for opening or closing the storage space; and
at least one translation hinge, wherein each translation hinge has two swing arms, and two ends of each swing arm are directly or indirectly mounted rotatably on the door and the case relative to the door and the case, respectively, such that each translation hinge and the door and the case form a parallelogram-shaped mechanism, allowing the door to translate to open or close the storage space.

2. The refrigerator according to claim 1, wherein the translation hinge further comprises:
a first connector fixed to an inner side surface of the door, one end of each swing arm being rotatably mounted to the first connector.

3. The refrigerator according to claim 2, wherein
the first connector comprises a body part fixed to a lateral side of the inner side surface of the door, and a bent part bent backwards from an end, away from the lateral centre of the door, of the body part;
one end of each of the two swing arms is rotatably mounted to the body part and the bent part, respectively.

4. The refrigerator according to claim 2, wherein the translation hinge further comprises:
a second connector fixed to the case, the other end of each swing arm being rotatably mounted to the second connector.

5. The refrigerator according to claim 4, wherein
the second connector comprises a base plate and a top plate which extend in the horizontal direction and are spaced apart from each other, and a connection part connected between the base plate and the top plate;
the other end of each swing arm is rotatably mounted between the base plate and the top plate.

6. The refrigerator according to claim 5, wherein
the number of the at least one translation hinge is two, and the two translation hinges are respectively arranged at the top and the bottom of the door.

7. The refrigerator according to claim 6, wherein
the base plate of the second connector of the upper translation hinge is mounted to a lateral end of a front edge of an upper surface of the case.

8. The refrigerator according to claim 6, wherein the bottom of the case is provided with an accommodating groove having an opening facing forward and being used for accommodating the two swing arms; and
the second connector of the lower translation hinge is mounted in the accommodating groove.

9. The refrigerator according to claim 1, wherein
the number of the at least one door assembly is two, and the two door assemblies are respectively mounted to two lateral sides in the front of the case, such that the two doors translate laterally toward each other so as to close the storage space and move laterally away from each other so as to open the storage space.

10. The refrigerator according to claim 1, wherein
the storage space is divided into a plurality of storage compartments, a plurality of door assemblies are provided, and each door assembly is mounted in front of one of the storage compartments so as to open or close the corresponding storage compartment.
